(19) United States
(12) Patent Application Publication
(10) Pub. No.: US 2005/0149885 A1
(43) Pub. Date: Jul. 7, 2005

(54) Rugged heterojunction bipolar transistor power device and the method thereof

(75) Inventors: Yu-Chi Wang, Tao Yuan Shien (TW); Jen-Hao Huang, Tao Yuan Shien (TW); Tsung-Chi Tsai, Tao Yuan Shien (TW); Min-Chang Tu, Tao Yuan Shien (TW)

Correspondence Address: DENNISON, SCHULTZ & DOUGHERTY, 612 CRYSTAL SQUARE 4, 1745 JEFFERSON DAVIS HIGHWAY, ARLINGTON, VA, 22202, US

(73) Assignee: WIN SEMICONDUCTORS CORP.

(21) Appl. No.: 10/747,051

(22) Filed: Dec. 30, 2003

(51) Int. Cl. G06F 17/50

(52) U.S. Cl. 716/2

(57) ABSTRACT

A rugged heterojunction bipolar transistor (HBT) power device and the optimal design method thereof are disclosed. By combining the epitaxial layer structure design (embedded emitter ballasting resistor and high breakdown voltage) and power cell design (clamping diodes and base ballasting resistor optimization), HBT power devices with excellent power performance and high ruggedness can be obtained.

### FIELD OF THE INVENTION

The present invention relates to an HBT power device with excellent power performance and extremely high ruggedness. The present invention also relates to an optimal design method for HBT power devices, more particularly, relates to a design method for HBT power devices by combining the epitaxial layer structure design (i.e., embedded emitter ballasting resistor and high breakdown voltage) and power cell design (i.e., clamping diodes and base ballasting resistor optimization), which can obtain an HBT power device with excellent power performance and extremely high ruggedness.

### BACKGROUND OF THE INVENTION

The modern power amplifiers for mobile phone require devices with great ruggedness to withstand extreme mismatch conditions in operation. Under severe load mismatch conditions, a large amount of output power delivered by the power transistor is dumped back to the RF power transistor itself and causes device catastrophic failure. Two of the commonest failure mechanisms are: (i) voltage swing exceeding the transistor breakdown voltage at the output stage and (ii) “hot spot” formation due to the uneven current distribution across the power transistor and eventually causing thermal runaway.

There are many possible factors that could affect the ruggedness of a power device at the transistor level, including epitaxial design, power cell design, process, bias scheme, and etc. Although these factors are correlated, the fundamental failure mechanisms are still (i) the breakdown voltage and (i) the hot spot formation.

I. Breakdown Voltage

High mismatch with a phase angle effectively presenting high impedance to the power device causes large voltage swing that may damage the device. FIG. 1A & 1B show the simulation result of a device biasing at V_{CE}=3.6 under high impedance mismatch, wherein the RF voltage could swing to 18 V. A device with higher emitter-collector breakdown voltage helps in this case. In practice, the breakdown voltage can be increased by increasing the collector layer thickness and/or lowering the collector layer doping concentration. As a result, the collector transit time is increased (lower cutoff frequency f_{T}) and the base push-out (also referred as Kirk effect) occurs at lower current density. However, for low frequency applications such as cellular and PCS frequency (below 2 GHz), the efficiency and gain will not be affected in a very significant way. Therefore, the collector layer thickness and doping concentration should be designed to obtain just enough breakdown voltage for ruggedness performance without sacrifice too much on the device high frequency performance. Additionally, one may choose to incorporate a diode series to clamp the excessive RF voltage swing. The clamping diodes are connected as described in FIG. 2. Under a high voltage-standing-wave-ratio (VSWR) condition and therefore a large voltage swing, the diode string turns on and sinks the current through the diodes instead of the power amplifier itself. The number of diodes in the string determines the headroom allowed for the signal voltage swing. The diode series has negligible effect on the impedance matching and the RF performance of the power device. It is effective in shunting the output when the voltage swing reaches a designed clamping level.

II. Hot Spot Formation

Emitter ballast is used to degenerate the unit cells to prevent current crowding in multiple emitter finger unit cell design. This is a trade-off against RF power efficiency. The rule of thumb is to choose a resistance with a voltage drop of about 1-2 kT/q (˜26-52 mV at room temperature). This is about 2-4 ohms for an 80-μm² device. We use an embedded high resistivity epitaxial layer in the emitter structure as the so-called “embedded emitter ballasting resistor” (EEBR) to prevent the sudden current increase across the emitter. There are two major advantages of using the EEBR, i.e. high positive resistivity temperature coefficient and short temperature response time (physically located on the hottest spot), as compared with the externally added emitter-ballasting resistor using thin-film resistor (TFR), such as NiCr and TaN. The EEBR layer could be either GaAs or AlGaAs material with high positive resistivity temperature coefficient (typically ˜2000 ppm), as compared with conventional TFR (e.g., ˜100-300 ppm for a TaN TFR). The high positive resistivity temperature coefficient of the EEBR layer can efficiently limit the current increase, since a larger voltage will drop on the EEBR layer, as compared with the externally added TFR emitter ballasting resistor of equivalent resistance. Secondly, because the EEBR layer is located right on the hottest spot (i.e., the emitter fingers), much shorter thermal time constant (of the order of ˜1 μs) is required to respond the temperature increase on the emitter before the device is burnt, which usually occurs within 1 ms. FIG. 3 shows a generic emitter epitaxial layer structure design with an EEBR layer. The EEBR layer thickness typically ranges from 100 to 300 nm with a doping concentration of about 10¹⁶-10¹⁷ cm⁻³. Base ballast is also equally helpful in preventing current crowding that leads to current collapse. One can either use series base resistor or shunting base resistor as shown in FIG. 4. The shunting ballast requires a capacitor to couple the RF signal.

### SUMMARY OF THE INVENTION

It is an object of the present invention to provide a rugged HBT power device that is able to withstand high VSWR conditions.

It is also an object of the present invention to provide a design method for an HBT power device that can possess extremely high ruggedness and excellent power performance.

These objects are achieved based on the investigations a series of devices with different designs, and the relevant factors that significantly affects the ruggedness and power performance of an HBT power device were singled out. These factors are the breakdown voltage, the use of clamping diodes, the embedded emitter ballasting resistor, and the base-ballasting resistor. By combining these factors, the HBT power device with excellent power performance and high ruggedness can be obtained.

In the present invention, the overdriven voltage swing is overcome by implementing both clamping diodes at the output stage and increasing the transistor intrinsic breakdown voltage. To avoid the hot spot formation, we design a special epitaxial structure, which includes an “embedded emitter ballasting resistor” (EEBR) layer, to effectively limit the sudden current increase under high voltage-standing-wave-ratio (VSWR) situation. We have done a thorough study on the factors affecting the power transistor ruggedness performance. We found that a device with excellent power performance and high ruggedness can be obtained by combining suitable epitaxial layer structure design (embedded emitter ballasting resistor and high breakdown voltage) and power cell design (clamping diodes and base ballasting resistor optimization). The optimum device is able to survive a 15:1 VSWR for a collector-emitter voltage of V_{CE}=3.6 V (or even up to 5 V) at both room temperature and 90° C. base plate temperature.

### BRIEF DESCRIPTION OF DRAWINGS

FIGS. 1A & 1B show the simulation result of a 7680 μm² power cell under high impedance mode, wherein FIG. 1A is shown Pout, power gain and PAE (Power Added Efficiency) at various input power levels, and FIG. 1B is shown the output voltage excursion at various input power driven up to 35 dBm.

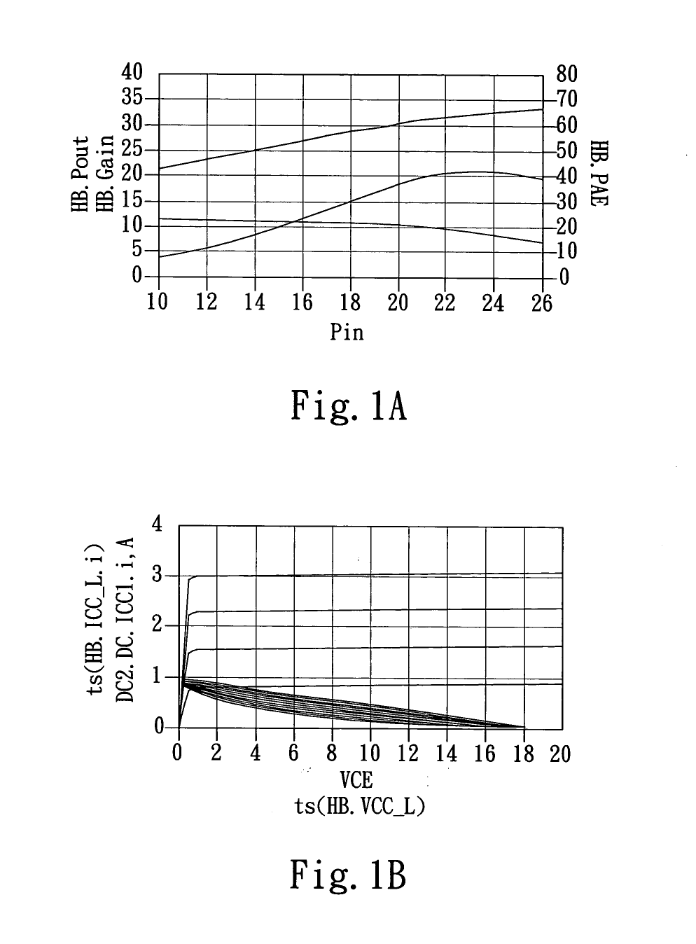

FIG. 2 illustrates the conventional connection of clamping diodes.

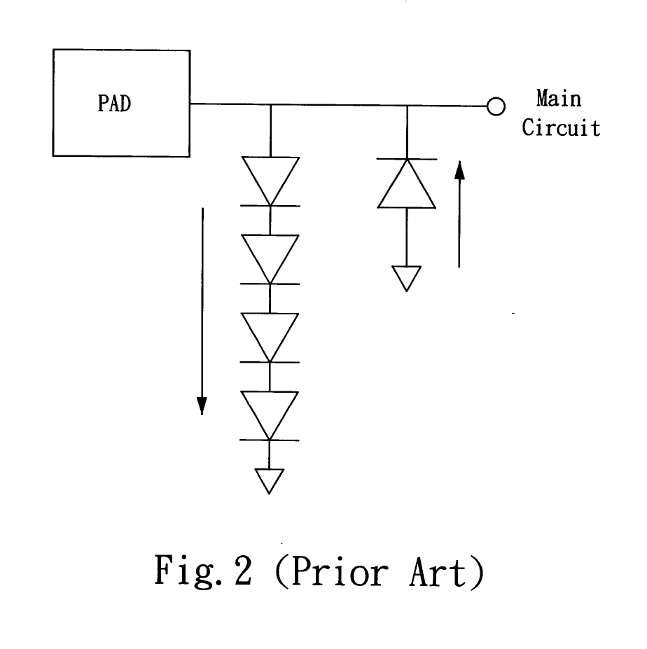

FIG. 3 is a generic emitter epitaxial layer structure design containing an EEBR layer.

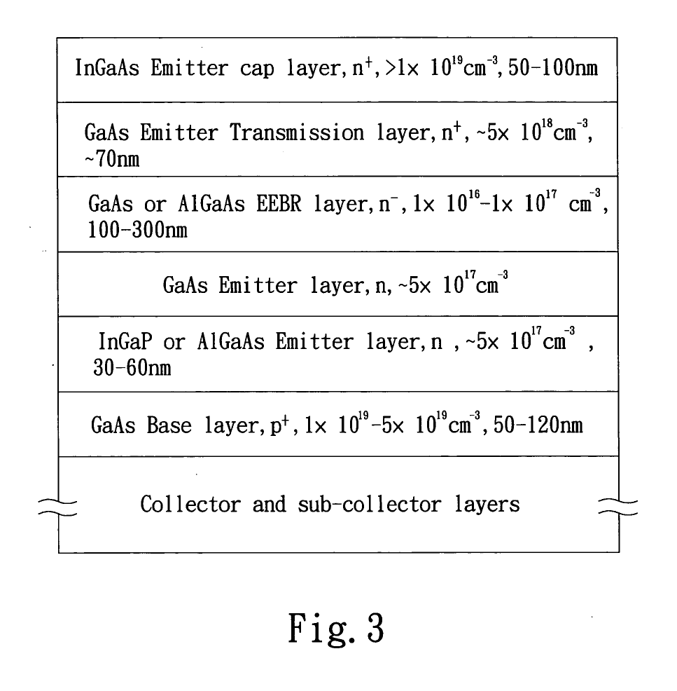

FIGS. 4A & 4B illustrate a conventional base ballast in series (A) and a base ballast in shunt (B) respectively.

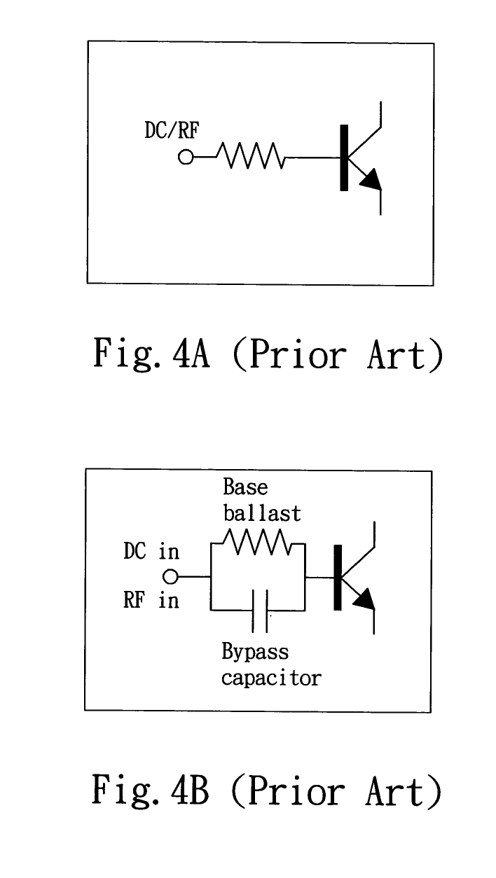

FIG. 5 summarizes the more detailed conditions used in the study for each factor

FIG. 6 shows the results of eight devices (labeled as A to H) covering the four major factors with different permutations have been tested.

FIG. 7 is the load-pull measurement result of the optimized device (Device H) at 900 MHz.

FIG. 8 is the plot of collector current vs. phase angle under different VSWR conditions.

### DETAILED DESCRIPTION OF THE INVENTION

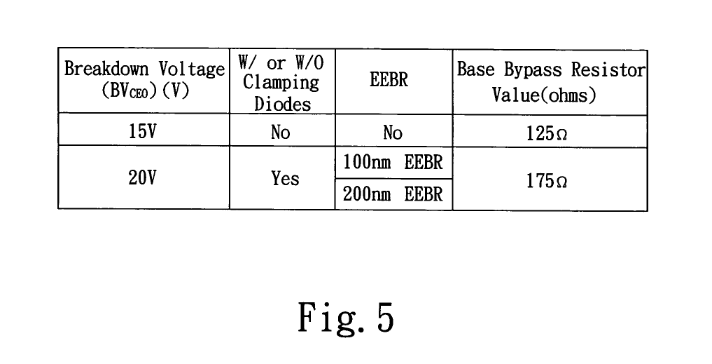

In order to find out the most important factors that significantly affects the ruggedness and performance of an HBT power device, a series of devices with different designs have been investigated. According to our investigations, four factors are found to be important to the ruggedness of an HBT power device, which are the breakdown voltage, the use of clamping diodes, the use of EEBR layer, and the optimization of base ballasting resistor. In FIG. 5, we summarizes the more detailed conditions used in the study for each factor.

The test procedures are described as follows. The base bias is connected to a voltage source to set the quiescent collector current at 200 mA. After setting the nominal bias at V_{CE}=3.6 V, the HBT device under test (DUT) is then tuned to a maximum power-added efficiency (PAE) at an output power of greater than 35 dBm. With the input power fixed at the level such that the DUT delivers output power of 35 dBm, a mismatch tuner is then set at a VSWR of 3:1 (while keeping the emitter-collector voltage V_{CE}=3.6 V) and the reflection phase is rotated through a full 360 degrees at the test frequency. Before moving to a higher VSWR mismatch condition, the DUT is monitored to ensure that there is no degradation in performance after post-stress. Then, the test is repeated through higher VSWR of 6:1, 8:1, 10:1, 12:1 and then 15:1. It is noted that after each mismatch test the DUT is checked, ensuring that there is no degradation in performance. Otherwise, the ruggedness test for this DUT is terminated. If the DUT passes the 15:1 VSWR at V_{CE}=3.6 V, then the V_{CE} is increased in 0.5 V/step until the V_{CE} reaches 5V The devices are tested at 900 MHz under CW mode all the time. The basic unit cell of the DUT consists of four emitter fingers. Each emitter finger is 2 μm wide and 40 μm long. The total emitter dimension for the basic unit cell is 320 μm². To obtain a fair comparison, a 7680 μm² power cell is used through the study.

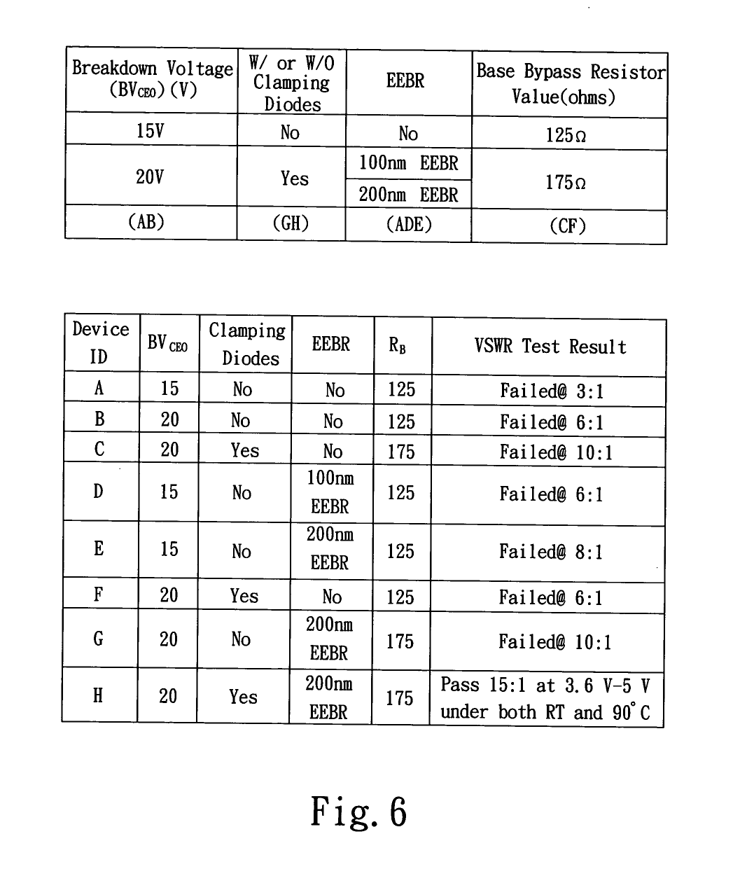

The results are summarized in FIG. 6, wherein eight devices (labeled as A to H) covering the four major factors with different permutations have been tested. By comparing the device A and B, the device with a collector-emitter breakdown voltage (BV_{CEO}) of 20 V shows improved VSWR performance, as compared with the device with BV_{CEO}=15 V. From results of devices A, D, and E, we found that the ruggedness performance was improved, with an ultimate VSWR increasing from 3:1, 6:1 to 8:1, as the resistor value the EEBR was increased. The base-ballasting resistor (R_{B}) also plays a role in optimizing the power transistor ruggedness performance. The influence of R_{B} can be inferred from the comparison between the device C and F. Increasing the R_{B} from 125 Ω to 175 Ω in effect improves the VSWR performance from 6:1 to 10:1. We also found that the use of clamping diode is also decisive to the device ruggedness. For the device G, which contains 20 V BV_{CEO}, 200 nm ERE layer, and 175 Ω R_{B}, the device is able to pass 8:1 VSWR but still failed at 10:1 VSWR. However, by adding clamping diodes at the output to clamp the voltage at 13 V, the device H passes 15:1 VSWR at V_{CE}=3.6 V to 5 V under both room temperature and 90° C. base plate temperature. The result has been verified for at least three times to show that indeed the H device is the most rugged power device by optimizing all the four major factors.

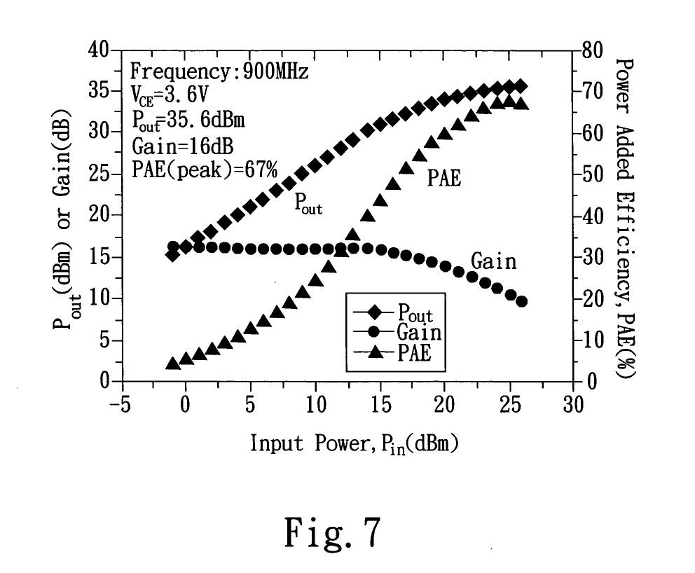

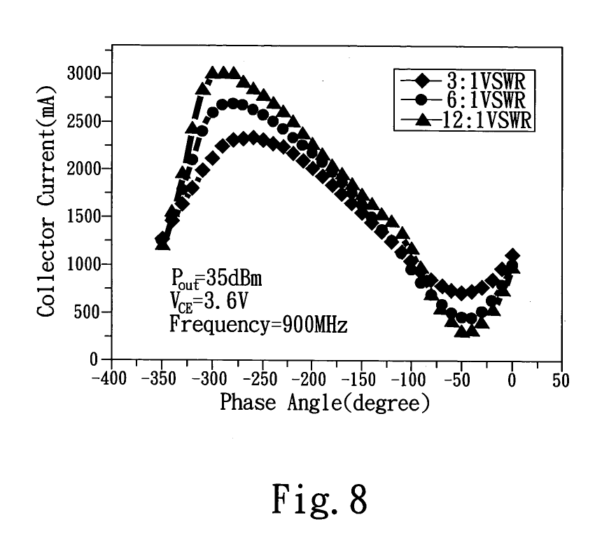

FIG. 7 shows the power sweep curve at 900 MHz from a load-pull system for the device H. The maximum output power is 35.6 dBm corresponding to a power density of 0.95 W/mm. The linear gain is 16 dB at 900 MHz. The power gain at Pₒᵤₜ of 35 dBm is 12-13 dB. The peak PAE is 67%, while the PAE at Pₒᵤₜ=35 dBm is around 64%. FIG. 8 shows the plot of collector current vs. phase angle under different VSWR conditions. The input power is fixed at the power level that, under matched condition, the transistor delivers an output power of 35 dBm. The maximum current occurs at the phase angle ranging from −257° to −300°. The current increases with the increasing VSWR. At a VSWR of 12:1, the current achieves slightly over 3 A. The power transistor passes 12:1 VSWR for all phases without showing performance degradation or damage.

According to the thorough study as described above, the relevant factors that affect the ruggedness performance of an HBT power device are now emerged. We conclude that a rugged HBT power device can be designed by considering the following three procedures:
a. optimizing the breakdown voltage of each HBT in the power device,
b. using clamping diodes at the output of each HBT in the power device, and
c. optimizing the base ballasting resistors connecting to the base of each HBT in the power device.
   On the other hands, if the clamping diodes were not used, the incorporation of EEBR is also helpful. Therefore, the procedure b can be replaced the consideration of
d. Incorporating an embedded emitter ballasting resistor in the emitter region of each HBT.

Finally, as has been demonstrated in our experimental results, an HBT power device with extremely high ruggedness and excellent power performance can be obtained by simultaneously considering the procedures a to d. In other words, by combining the epitaxial layer structure design (embedded emitter ballasting resistor and high breakdown voltage) and power cell design (clamping diodes and base ballasting resistor optimization), we can obtain a device being able to survive a 15:1 VSWR at V_{CE}=3.6V to 5V under both room temperature and 90° C. base plate temperature.

1. A method for improving the ruggedness of HBT (Heterojunction Bipolar Transistor) power devices, comprising the following proceedings:
a. Optimizing the breakdown voltage of each heterojunction bipolar transistor in the HBT power device cell,
b. Using clamping diodes at the output of the heterojunction bipolar transistor in the HBT power device cell, and
c. Optimizing the base ballasting resistors connecting to the base of each heterojunction bipolar transistor in the HBT power device cell.

2. The method for improving the ruggedness of HBT power devices as described in claim 1, wherein the breakdown voltage of each heterojunction bipolar transistor is optimized by suitable epitaxial-layer design.

3. The method for improving the ruggedness of HBT power devices as described in claim 1 wherein the breakdown voltage of each heterojunction bipolar transistor is preferred between 18 volts and 25 volts.

4. A method for improving the ruggedness of HBT power devices, comprising the following proceedings:
a. Optimizing the breakdown voltage of each heterojunction bipolar transistor in the HBT power device cell,
b. Incorporating an embedded emitter ballasting resistor in the emitter region of each heterojunction bipolar transistor, and
c. Optimizing the base ballasting resistors connecting to the base of each heterojunction bipolar transistor in the HBT power device cell.

5. The method for improving the ruggedness of HBT power devices as described in claim 4, wherein the breakdown voltage of each heterojunction bipolar transistor is optimized by suitable epitaxial-layer design.

6. The method for improving the ruggedness of HBT power devices as described in claim 4, wherein the incorporation of embedded emitter ballasting resistor is achieved by using a layer of wider bandgap material with lower doping concentration inserted in the emitter region of each heterojunction bipolar transistor.

7. The method for improving the ruggedness of HBT power devices as described in claim 6, wherein the resistivity of said embedded emitter ballasting resistor is optimized by changing the thickness, the doping concentration and the alloy composition of the layer of wider bandgap material.

8. The method for improving the ruggedness of HBT power devices as described in claim 4 further, comprising the following proceeding:
d. Using clamping diodes at the output of the heterojunction bipolar transistor in the HBT power device cell.

9. The method for improving the ruggedness of HBT power devices as described in claim 8, wherein the breakdown voltage of each hetero junction bipolar transistor is tuned by suitable design of its epitaxial layer structure.

10. The method for improving the ruggedness of HBT power devices as described in claim 4 wherein the breakdown voltage of each heterojunction bipolar transistor is preferred between 18 volts and 25 volts.

11. The design method for improving the ruggedness of HBT power devices as described in claim 8, wherein the incorporation of embedded emitter ballasting resistor is achieved by using a layer of wider bandgap material with lower doping concentration inserted in the emitter region of each heterojunction bipolar transistor.

12. The design method for improving the ruggedness of HBT power devices as described in claim 11, wherein the resistivity of said embedded emitter ballasting resistor is optimized by changing the thickness, the doping concentration and the alloy composition of the layer of wider bandgap material.

13. An HBT power device, comprising:
A plurality of heterojunction bipolar transistor, each of said transistor having an emitter, a base and a collector and each of said bases being connected to an base ballasting resistor, and a series of clamping diodes are further connected to the output of said transistor for clamping the output voltage at a certain voltage level.

14. The HBT power device as described in claim 13, wherein each of bases is connected to a shunt coupling capacitor.

15. The HBT power device as described in claim 13, wherein the emitter of each said transistor have an embedded emitter-ballasting resistor.

16. An HBT power device as described in claim 15, wherein the embedded emitter-ballasting resistor is a layer of wide bandgap material with lower doping concentration.
